(19) United States
(12) Patent Application Publication
(10) Pub. No.: US 2016/0328306 A1
(43) Pub. Date: Nov. 10, 2016

(54) INTERFACE TEST DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: JIN-SHAN MA, Shenzhen (CN); WEN-HAO DAI, Shenzhen (CN)

(21) Appl. No.: 14/808,674

(22) Filed: Jul. 24, 2015

(30) Foreign Application Priority Data
May 8, 2015 (CN) 201510234063.8

(51) Int. Cl. G06F 11/273; G06F 11/22

(52) U.S. Cl. CPC G06F 11/2733; G06F 11/221

(57) ABSTRACT

An interface test device includes several interfaces, a test signal input interface, a control signal input interface, and a control module. The interface test device is connected between an electronic device and a computer. The interface test device receives control signals from the computer through the control signal input interface. The interface test device selectively outputs test signals to the electronic device through test interfaces corresponding to the control signals.

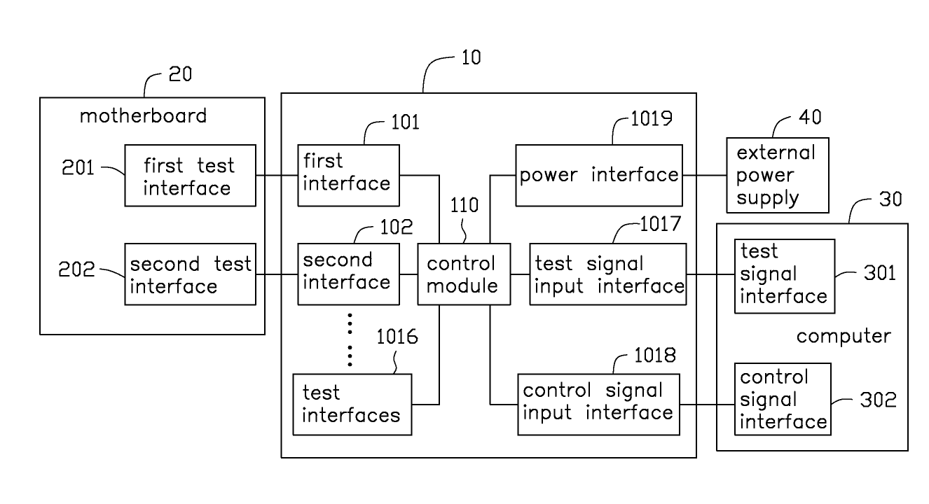

### FIELD

The subject matter herein generally relates to an interface test device.

### BACKGROUND

An interface should be coupled to a device which has an independent internet protocol address to get an identifiable signal.

### BRIEF DESCRIPTION OF THE DRAWING

Implementations of the present technology will now be described, by way of example only, with reference to the attached FIGURE.

The FIGURE is a block diagram of an embodiment of an interface test device.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series and the like.

The FIGURE illustrates an embodiment of the interface test device 10. The interface test device 10 can comprise a first interface 101, a second interface 102, a test signal input interface 1017, a control signal input interface 1018, a power interface 1019, and a control module 110. The interface test device 10 is coupled between an electronic device and a computer 30. In the embodiment the electronic device is a motherboard 20.

The first interface 101 is coupled to a first test interface 201 of the motherboard 20. The second interface 102 is coupled to the second test interface 202 of the motherboard 20. The test signal input interface 1017 is coupled to a test signal interface 301 of the computer 30. The control signal input interface 1018 is coupled to a control signal interface 302 of the computer 30.

The power interface 1019 is coupled to an external power supply 40. The external power supply 40 supplies power for the interface test device 10. In other embodiments, the interface test device 10 can get power from an internal power module. The interface test device 10 can also couple to the computer 30 through the power interface 1019 to get power from the computer 30.

The control module 110 is coupled to the first interface 101, the second interface 102, the test signal input interface 1017, the control signal input interface 1018, and the power interface 1019. The computer 30 outputs different test signals to the test signal input interface 1017 through the test signal interface 301. The computer 30 outputs different control signals to the control signal input interface 1018 through the control signal interface 302. The control module 110 outputs different test signals selectively to the first interface 101 or the second interface 102, according to different control signals received.

To test the first test interface 201, the computer 30 outputs a first control signal through the control signal interface 302. The control module 110 receives the first control signal and outputs a first test signal to the first test interface 201.

To test the second test interface 202, the computer 30 outputs a second control signal through the control signal interface 302. The control module 110 receives the second control signal and outputs a second test signal to the second test interface 202.

In the embodiments, the interface test device 10 can comprise test interfaces 1016 which are coupled to the control module 110. The computer 30 outputs different control signals to the control module 110. The control module 110 outputs different test signals to a tested interface of the electronic device, according to the different control signals from the computer 30.

In the embodiment, the computer 30 can output a third control signal. The interface device 10 receives the third control signal, and outputs a third test signal to the first test interface 201 and the second test interface 202, to test both of the first test interface 201 and the second test interface 202 synchronously.

In the embodiment, the first interface 101, the second interface 102, the first test interface 201, the second test interface 202, and the test interfaces 1016 are RJ45 connectors. The control module 110 is a single chip microcomputer.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An interface test device coupled to an electronic device and a computer, the interface test device comprising:
a plurality of interfaces configured to be coupled to a plurality of test interfaces of the electronic device respectively;
a test signal input interface configured to be coupled to the computer to receive different test signals;
a control signal input interface configured to be coupled to the computer to receive different control signals; and
a control module coupled to the plurality of interfaces, the test signal input interface, and the control signal input interface, and output different test signals to the test interfaces of the electronic device through the plurality of interfaces, according to the control signals.

2. The interface test device as claim 1, further comprising a power interface, wherein the power interface is configured to be coupled to an external power supply, the external power supply is configured to supply power for the interface test device.

3. The interface test device as claim 1, wherein the electronic device is a motherboard, a first tested interface of the motherboard is coupled to a first interface of the interface test device.

4. The interface test device as claim 3, wherein when the computer outputs a first control signal through a control signal interface of the computer to the control module, the control module outputs a corresponding test signal to the first tested interface of the motherboard through the first interface.

5. The interface test device as claim 4, wherein the motherboard comprises a second tested interface, the interface test device comprises a second interface coupled to the second tested interface, when the computer outputs a second control signal through the control signal interface of the computer to the control module, the control module outputs a corresponding test signal to the second tested interface of the motherboard through the second interface of the interface test device.

6. The interface test device as claim 4, wherein when the computer outputs a third control signal through the control signal interface of the computer to the control module, the control module outputs a corresponding test signal to the first tested interface and the second tested interface of the motherboard, for testing the first and second tested interfaces synchronously.

7. The interface test device as claim 5, wherein the first and second tested interfaces and the first and second interfaces are RJ45 connectors.

8. The interface test device as claim 1, wherein the control module is a single chip microcomputer.
